(19) United States
(12) Patent Application Publication
(10) Pub. No.: US 2006/0068165 A1
(43) Pub. Date: Mar. 30, 2006

(54) Covering device for motor vehicles

(76) Inventor: Oliver Wolf, Starzach (DE)

Correspondence Address: DREISS, FUHLENDORF, STEIMLE & BECKER, POSTFACH 10 37 62, D-70032 STUTTGART, DE

(21) Appl. No.: 10/526,352

(22) PCT Filed: Sep. 5, 2003
(86) PCT No.: PCT/EP03/09871

§ 371 Date: Mar. 2, 2005

(30) Foreign Application Priority Data
Sep. 6, 2002 (DE) 102 47 794.6
Sep. 17, 2002 (DE) 102 43 254.6

(51) Int. Cl. B32B 3/10

(52) U.S. Cl. 428/136

(57) ABSTRACT

The invention relates to a covering device (10) for vehicles, the device comprising a tarpaulin (12) which can be placed on or against the windows of a vehicle. At least one material section is provided for fixing the covering device (10) to the vehicle in a detachable manner. According to the invention, the material section can be fixed in a closable opening of a vehicle, especially in the opening region of a door and/or, the trunk and/or the engine compartment.

The invention concerns a covering device for vehicles, in particular, for motor vehicles, comprising a tarpaulin which can be disposed onto or against the windows of a vehicle.

To protect a vehicle from weather influences, in particular, to prevent icing of vehicle windows in the winter or to prevent heating of the vehicle interior in the summer, conventional car covers are fastened to the motor vehicle using tightening straps. The conventional tightening straps comprise hooks which can be secured e.g. in the fender region of the motor vehicle. It has turned out that this type of mounting is not very reliable since the motor vehicle often has no suitable regions to receive the tightening strap hooks. The tightening straps may become loose and the tarpaulin loosely disposed on the motor vehicle to become detached from the vehicle, in particular, due to heavy wind.

In view of the above, it is the underlying purpose of the invention to provide a covering device for vehicles which can be mounted to the vehicle in a reliable and simple fashion.

This object is achieved in accordance with the invention in that at least one material section is provided to form a detachable mounting of the covering device on the vehicle, which can be fixed in a closable opening of a vehicle, in particular, in a door and/or trunk and/or engine space opening region.

The material section may be clamped between an opening of the chassis forming the vehicle, and a chassis part, in particular, a door or a flap.

The material section may be formed by a tarpaulin section and/or an additional element.

The material section is preferably provided in the edge region of the tarpaulin. If this material section is designed as an elongated strip, wherein at least one of its short front ends is integrally formed with the tarpaulin, the strip may be fixed with one of its free ends in a vehicle opening.

The strip may be divided to form two strip sections to permit adjustment to the vehicle geometry, and also to be able to fix and/or clamp both strip sections on the vehicle.

The strip may comprise breaking points which facilitate separation of the strip into strip sections. The strip can also be separated into two strip sections using a knife or scissors.

In an alternative fashion, mounting means may be provided to detachably connect tarpaulin sections. These mounting means may e.g. have an opening for receiving at least portions of a shackle. Preferably, several slot-shaped openings are provided which can be introduced into the shackle. Towards this end, the shackle advantageously comprises an insertion aid.

The tarpaulin may have openings to receive exterior mirrors of the vehicle to permit tight abutment of the tarpaulin on the vehicle, thereby ensuring good protection.

The tarpaulin may also be fixed by the windshield wipers of the vehicle.

The covering device may comprise a roof portion which is suited to cover the roof of a vehicle thereby forming a domed or partial domed car cover. The roof portion may comprise an opening for receiving a component which projects from the roof of the vehicle, in particular, an antenna. If the covering device has a roof portion, this roof portion can seat closely on the vehicle roof without requiring dismantling of components projecting from the vehicle, such as e.g. an antenna.

The roof portion may be omitted such that the covering device can be disposed around the windows of a vehicle, in particular, around the front, side and rear windows.

The invention also concerns a covering material and/or window covering material.

The windows are covered by a material which can be disposed around the windows of a vehicle.

The disadvantage of the conventional covers is avoided by mounting a material which leaves a free space on the roof, such that the roof antenna need not be removed to mount the cover.

The present material is a foil which prevents icing in the winter and heating in the summer. The foil permits covering the front window, side windows and rear window without thereby covering the roof. This is particularly advantageous for vehicles having a roof antenna.

The invention also concerns a device for mounting a car cover, wherein, in particular, the device is mounted to the covering device but is not provided as part of the cover.

There are conventional devices with which part of the cover is designed such that part of the structure has the same shape for clamping into the vehicle.

The invention concerns devices which can be mounted to the cover to be clamped into the vehicle.

The invention concerns a device which permits mounting of a covering device for vehicles on the vehicle which is realized by providing additional loops on the covering device.

Further advantageous embodiments and details of the invention can be extracted from the present description which describes and explains the invention in more detail with reference to embodiments shown in the drawing.

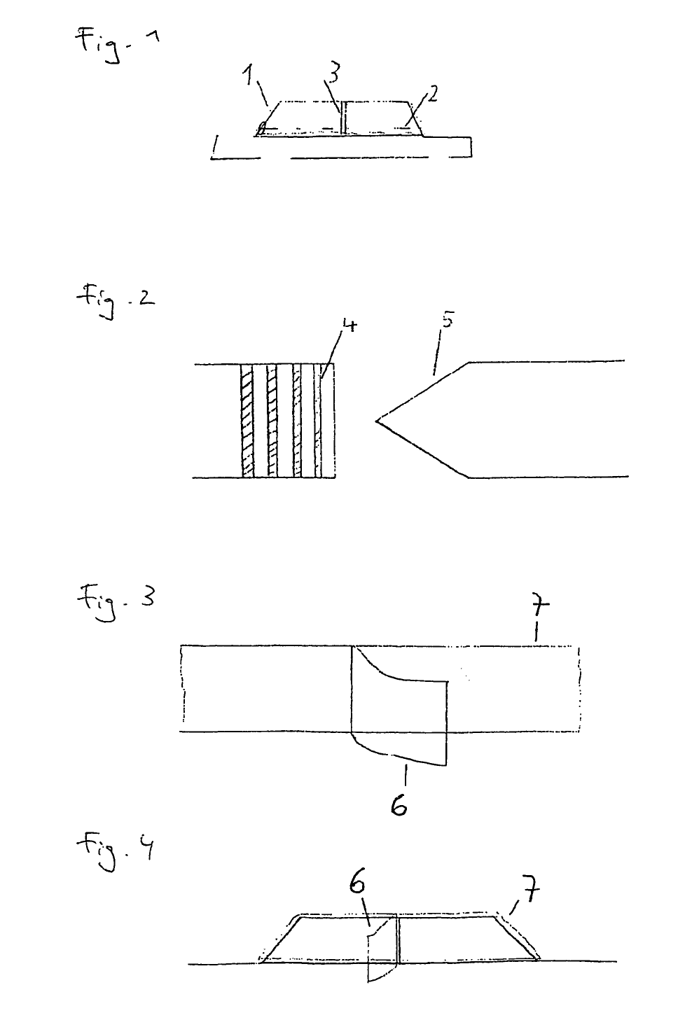

FIG. 1 shows a motor vehicle with inserted covering foil;

FIG. 2 shows a device with loops to permit threading the end of the foil with the beginning of the foil;

FIG. 3 shows a device which is mounted to the existing covering foil to permit mounting to a vehicle;

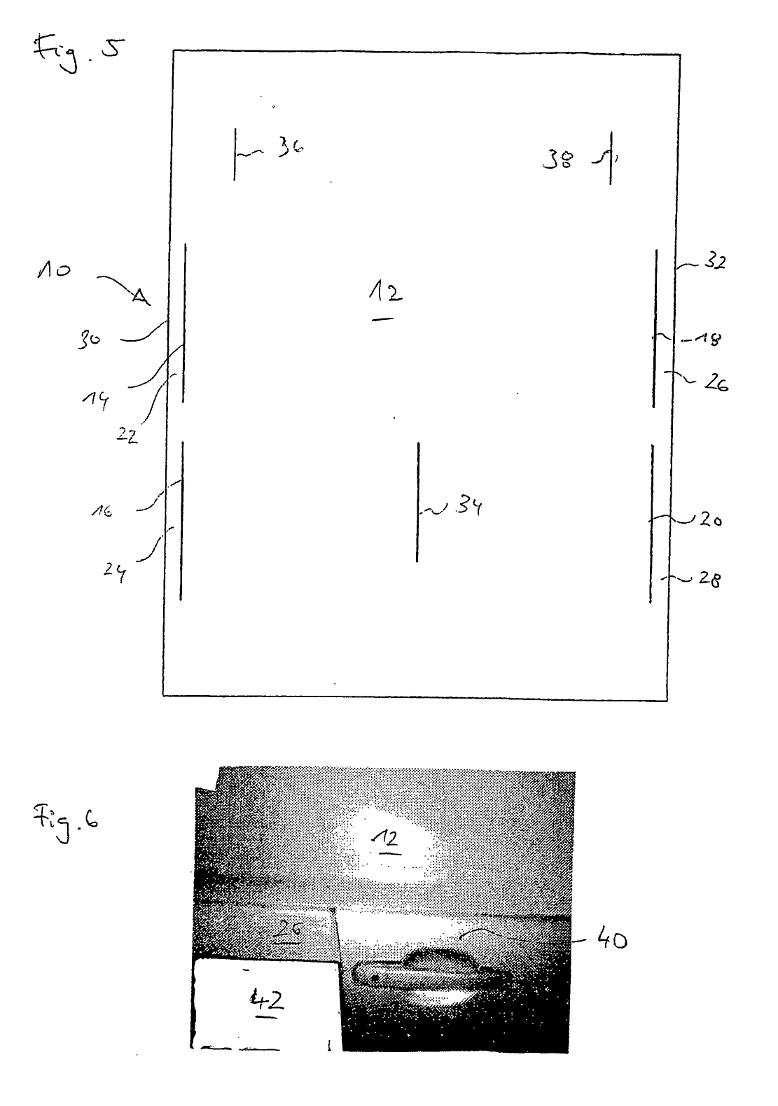

FIG. 4 shows a loop which has been clamped into a door;

FIG. 5 shows a top view onto an inventive covering device; and

FIG. 6 shows a section of a side view of a covering device fixed to a vehicle.

FIG. 1 schematically shows the outer contour of a motor vehicle which is covered by a covering device. The covering device is also designated below as a foil 1, a covering foil 1, a tarpaulin or a covering material.

The covering device may be produced from plastic material, e.g. of polyethylene PE. The covering device or at least parts thereof may be provided with a further coating e.g. an aluminum coating. Regions of the covering device may have different colors.

The front side of the foil 1 is indicated by an area having a different color. The lower part of the foil is indicated by a marking 2. The beginning of the covering foil 3 is introduced into an open door which is subsequently closed. The overall covering foil is then guided around the vehicle.

A section of the described covering device, i.e. its leading end, is intended to be fixed in a closable opening, e.g. the door of the motor vehicle. The covering device covers all side surfaces of the vehicle, in particular, its windows, whereas the roof area of the motor vehicle is not or only incompletely covered.

Mounting to the front window is realized using the windshield wipers and the passenger side may be covered by introducing the foil into a door gap. Moreover, the holes provided in the foil may pass the exterior mirrors which further improves fixing of the foil. Fixation on the rear window may be provided by an optional windshield wiper.

FIG. 2 shows the front and the rear ends of the covering device of FIG. 1 in the disconnected or detached state.

The front end of the covering foil 4 has several loops. The rear end of the covering foil 5 has a bevelled end.

To mount the rear end of the covering foil, the covering foil is guided through the loops at the front end of the covering foil in an alternating fashion, at the top and bottom, to ensure stability.

The loops are mounting means for connecting and disconnecting the front and rear ends of the covering device.

The loops form, in particular, openings for passage of the rear end of the covering device, formed as tab. The bevelled end of the tab assists insertion.

FIG. 3 shows a covering device comprising a section provided to fix the covering device on a motor vehicle. FIG. 4 schematically shows the outer contour of a motor vehicle which is covered with the covering device of FIG. 3. The covering device is also referred to below as a cover 7, tarpaulin or covering material.

Mounting is accomplished by mounting a loop 6 on the cover 7. This loop 6 may be introduced into the door gap when the cover is applied and the door can then be closed. This loop may also be introduced into the window or trunk, which are subsequently closed.

The loop thereby represents a section of the covering device for detachably mounting the covering device on the motor vehicle.

The loop may be designed as tarpaulin section or be provided as an additional element.

The covering device may comprise a roof portion to cover the roof of the motor vehicle. The roof portion may also have one or more openings for passage of a component which projects from the roof of the vehicle.

FIG. 5 shows a covering device which is generally designated by reference numeral 10. It has a tarpaulin 12 having a substantially rectangular shape. The lateral edge region of the tarpaulin 12 has four slots 14, 16, 18, and 20. These slots 14 through 20 delimit strips 22, 24, 26, and 28 which are provided between the slots 14 through 20 and the side edges 30 or 32 of the tarpaulin 12. The function of the strips 22 through 28 is explained with reference to FIG. 6 below.

The tarpaulin 12 may be used to cover a vehicle, in particular, a motor vehicle. In the covered state, the tarpaulin 12 covers the front window, the side windows, the rear window and the roof of the vehicle.

The tarpaulin 12 also has a central slot 34 for receiving a component which projects from the roof of the vehicle, such as e.g. an antenna, when the tarpaulin 12 is disposed onto a vehicle.

The tarpaulin 12 moreover comprises two slots 36 and 38 to receive the exterior mirrors of a vehicle.

FIG. 6 shows part of the tarpaulin 12 shown in FIG. 5 and part of the strip 26. The section of the strip 26 shown in FIG. 6 is produced in that, in particular, at first-time use of the covering device, the user separates the strip 26 shown in FIG. 5 into two strip sections.

A section of the strip 26 (FIG. 6) can then be clamped between a door 40 shown in FIG. 6 and a chassis section 42. The same may be done for one or more of the other strips 24, 26, 28.

The tarpaulin 12 can thereby be detachably mounted to the vehicle via at least one material section, this material section being a tarpaulin section provided by a strip disposed in the edge region of the tarpaulin.

1-28. (canceled)

29. A covering device for a vehicle and for a motor vehicle, the device comprising:
a tarpaulin, said tarpaulin structured and dimensioned for placement onto or against windows of the vehicle; and
at least one material section cooperating or integral with said tarpaulin to form a detachable mounting of the covering device on the vehicle, said at least one material section structured and dimensioned for fixing in a closable opening of the vehicle.

30. The covering device of claim 29, wherein the closable opening is a door, a trunk, or a hood.

31. The covering device of claim 29, wherein said material section can be clamped between a chassis defining the closable opening of the vehicle and a chassis part for closing the opening.

32. The covering device of claim 29, wherein the chassis part is a door or a flap.

33. The covering device of claim 29, wherein said material section is formed by a tarpaulin section.

34. The covering device of claim 29, wherein said material section is an additional element.

35. The covering device of claim 29, wherein said material section is provided in an edge region of said tarpaulin.

36. The covering device of claim 29, wherein said material section is formed as an elongated strip which is integral with said tarpaulin at at least one narrow end thereof.

37. The covering device of claim 36, wherein said strip can be separated in a region between narrow ends thereof to form two strip sections.

38. The covering device of claim 36, wherein said stip has intended separation locations.

39. The covering device of claim 29, further comprising mounting means for detachable connection between tarpaulin sections.

40. The covering device of claim 39, wherein said mounting means have at least one opening which receives at least part of a tab.

41. The covering device of claim 40, wherein said at least one opening is a slotted opening.

42. The covering device of claim 40, wherein said tab comprises an insertion aid.

43. The covering device of claim 29, wherein said tarpaulin has openings to receive external mirrors of the vehicle.

44. The covering device of claim 29, wherein sections of said tarpaulin can be fixed on the vehicle using windshield wipers.

45. The covering device of claim 29, wherein said tarpaulin comprises a roof portion which is suited to cover a roof of the vehicle.

46. The covering device of claim 45, wherein said roof portion has an opening for receiving a component which projects from the vehicle roof or for receiving an antenna.

47. The covering device of claim 29, wherein no roof portion is provided.

48. The covering device of claim 29, wherein said tarpaulin comprises sections which are suited to cover a front window, side windows, and a rear window of the vehicle.

49. A device for mounting a cover onto a vehicle and a motor vehicle, the cover being structured and dimensioned for placement onto or against windows of the vehicle, the device comprising:
means cooperating with said cover to form a detachable mounting of the cover on the vehicle.

50. The mounting device of claim 49, wherein the device is structured and dimensioned to mount the cover by opening and closing the vehicle.

51. The mounting device of claim 49, wherein the mounting device is made from a same or a similar material as the cover.

52. The mounting device of the claim 49, wherein the mounting device is not disposed on an edge of the cover.

53. A material for covering a vehicle and a motor vehicle, the material being structured and dimensioned for placement onto or against windows of the vehicle to cover all lateral surfaces of the vehicle without completely covering a roof thereof.

54. The covering material of claim 53, wherein the covering material comprises at least two different colors.

55. The covering material of claim 53, further comprising a device cooperating with the covering material for mounting the covering material to the vehicle.

56. The covering material of claim 55, wherein said mounting device comprises a material which is similar to the covering material.

57. The covering material of the claim 53, wherein the covering material has means for providing passage for external mirrors.

58. The covering material of claim 53, wherein a beginning or an end of the covering material does not terminate at right angles.
